(19) United States
(12) Patent Application Publication
(10) Pub. No.: US 2008/0143753 A1
(43) Pub. Date: Jun. 19, 2008

(54) Method and device of rapidly generating a gray-level versus brightness curve of a display

(75) Inventors: Mang Ou-Yang, Taipei Hsien (TW); Shih-Wei Huang, Taipei Hsien (TW); Jiun-Chian Liao, Taipei Hsien (TW); Gordon Horng, Taipei Hsien (TW); Tsang-Hsing Lee, Taipei Hsien (TW); Yih-Shyang Chen, Taipei Hsien (TW)

Correspondence Address: BACON & THOMAS, PLLC, 625 SLATERS LANE, FOURTH FLOOR, ALEXANDRIA, VA, 22314, US

(73) Assignee: Wistron Corporation, Taipei Hsien (TW)

(21) Appl. No.: 11/826,410

(22) Filed: Jul. 16, 2007

(30) Foreign Application Priority Data
Dec. 13, 2006 (TW) 095146776

(51) Int. Cl. G09G 5/10; G09G 5/00

(52) U.S. Cl. 345/690; 345/207

(57) ABSTRACT

A method of rapidly generating a gray-level versus brightness curve of display causes a color display to display a test image that includes a plurality of block images. Each block image has different gray-level value. By using a light detector and a color analyzing device, corresponding brightness values of the gray-level values can be obtained. Therefore, a gray-level versus brightness curve can be generated according to the gray-level values and their corresponding brightness values.

### BACKGROUND OF THE INVENTION

1. Field of the Invention

The present invention relates to a method and related device of rapidly generating a gray-level versus brightness curve of a display, in which the display may be a liquid crystal TV, liquid crystal display, plasma TV, projector, etc.

2. Description of the Related Art

A gray-level versus brightness curve of a display is a curve of the relationship between different gray-level values and their corresponding brightness values. The gray-level value may be assigned to the x axis, while the brightness value may be assigned to the y axis; the resulting curve is called the “gray-level versus brightness curve”. As the gray-level versus brightness curve is approximately equal to the mathematical gamma curve (Y=X̂r, γ curve, or gamma curve), the gray-level versus brightness curve may also be called a gamma curve.

Different displays have different gray-level versus brightness curves. As a result, to provide consistently high product qualities for displays, the gray-level versus brightness curve of each display must be measured. By obtaining the gray-level versus brightness curve of the display, the manufacturer learns of the characteristics of the display, which may be used to further adjust the color settings of the display.

In a prior art patent, entitled: “SYSTEM AND METHOD FOR PANEL DISPLAY TELEVISION ADJUSTMENT” (JP patent No. 2005057543, U.S. Pat. No. 6,043,797, TW patent No. 00583624), a system to measure the brightness of a TV is used to perform γ compensation correction for the TV.

The measuring method of the system utilizes a computer (a PC) to consecutively send gray-level signals to the display, a light sensor to capture the brightness-related data from the panel of the display, and sends all of the data back to the computer for processing to obtain a gray-level versus brightness curve (voltage as a value suitably corresponds to brightness for the distribution curve) of the display. After a graphic generator sends graphic signals to the display, the light sensor makes measurements and sends the mesured data to the computer; this cycle requires one second. To obtain 8 bits of red, green and blue, the three primary colors, and gray values for a continuous gray-level versus brightness curve, in which gray (or white) may be considered another primary color, requires 1 (sec)×256 (gray-level values)×4 (primary colors), which is about 17 minutes. Since each work station on the production line has a short period of time to work, if the γ compensation correction procedure for the display is performed on the production line, a significant cost in terms of time will be imposed by the measurement, which is a reason why γ compensation correction for the display is difficult to perform on the production line.

Therefore, it is desirable to provide a method and device of rapidly generating a gray-level versus brightness curve of a display to mitigate and/or obviate the aforementioned problems.

### SUMMARY OF THE INVENTION

A main objective of the present invention is to provide a method of rapidly generating a gray-level versus brightness curve of a display.

A device for rapidly obtaining a gray-level versus brightness curve of the present invention includes a light sensor, a color analyzer, a computer, and a signal generator. The signal generator is electrically connected to the color display that is to be tested, the light sensor is electrically connected to the color analyzer, and the color analyzer is electrically connected to the computer.

The signal generator outputs an image signal to the color display to cause the display to display a test image. The test image therefore displays a plurality of block images with different gray-level values. The light sensor is utilized to capture the test image to generate captured image information and sends the captured image information to the color analyzer. The color analyzer analyzes the captured image information to obtain the corresponding brightness values of different gray-level values in the block images. The computer generates a gray-level versus brightness curve according to the plurality of brightness values and their corresponding plurality of gray-level values.

Other objects, advantages, and novel features of the invention will become more apparent from the following detailed description when taken in conjunction with the accompanying drawings.

### BRIEF DESCRIPTION OF THE DRAWINGS

FIG. 1 is a drawing showing the utilization of a computer, light sensor, color analyzer and signal generator to search a gray-level versus brightness curve according to the present invention.

FIG. 2 is a flow chart of obtaining a gray-level versus brightness curve according to the present invention.

FIG. 3 is a drawing of utilizing a light sensor to capture a testing image.

FIG. 4 is another drawing of the testing image.

FIG. 5 is a drawing of a gray-level versus brightness curve.

### DETAILED DESCRIPTION OF THE PREFERRED EMBODIMENT

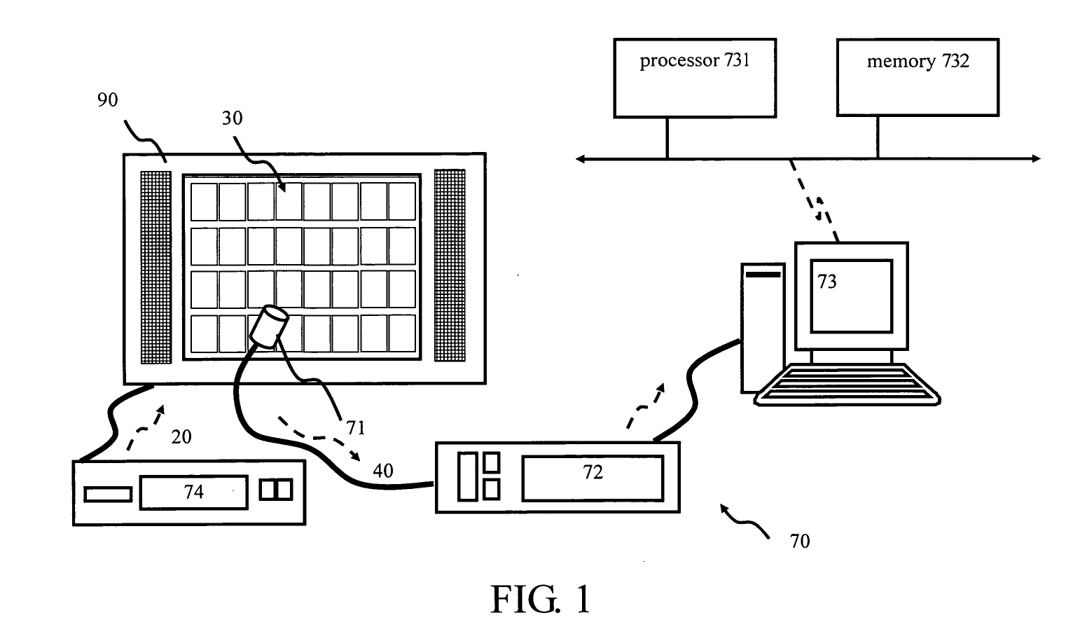

Please refer to FIG. 1. FIG. 1 is an environmental drawing of a device for searching a gray-level versus brightness curve 70 according to the present invention. The device for rapidly searching a gray-level versus brightness curve 70 comprises a light sensor 71, a color analyzer 72, a computer 73, and a signal generator 74. The signal generator 74 is electrically connected to the color display 90 that is to be tested, the light sensor 71 is electrically connected to the color analyzer 72, and the color analyzer 72 is electrically connected to the computer 73.

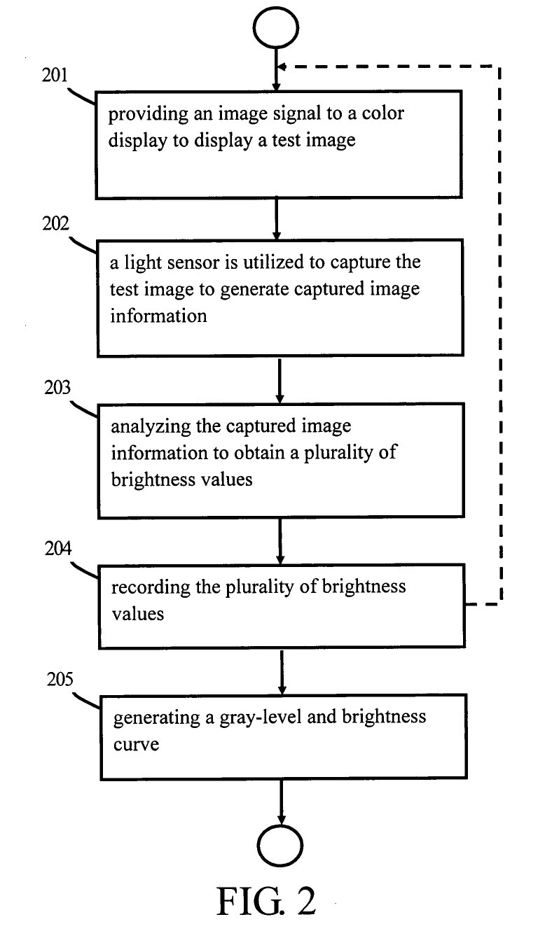

Please refer to FIG. 2. FIG. 2 is a flow chart of obtaining a gray-level versus brightness curve according to the present invention.

### Step 201:

The signal generator 74 outputs an image signal 20 to the color display 90 to display a test image 30.

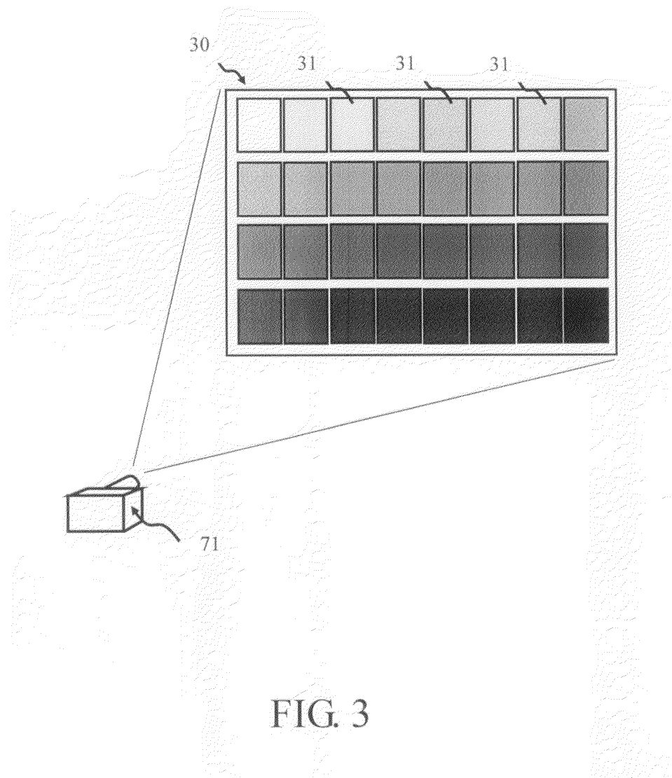

In the present invention, the image signal 20 includes a plurality of image signals having different gray-level values. The test image 30 therefore displays a plurality of block images with different gray-level values. Please refer to FIG. 3. For example, 32 gray-level diagrams may be displayed. The test image 30 includes 32 block images 31, and each block image 31 has a different corresponding gray-level value.

The test image 30 is usually a pure color, normally white, red, green and blue are usually the colors that are used to obtain the gray-level versus brightness curve of the display. In prior art, each measured test image had only one gray-level value, whereas the test image 30 of the present invention has a plurality of block images 31 with different gray-level values.

A typical gray-level versus brightness curve may include 0 to 255 gray-level values; for example, the test image 30 may include 32 green block images 31, in which first displayed 32 block images 31 present 0 to 31 gray-level diagrams for green. Hence, to display all gray-level diagrams for green, the test image 30 should be generated eight times.

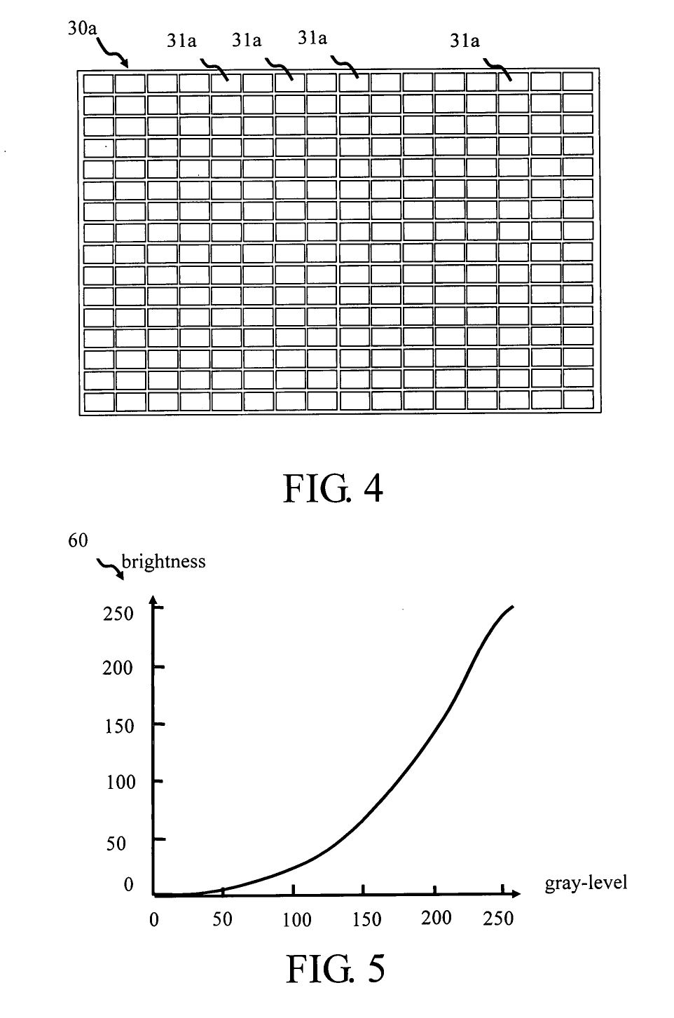

Please refer to FIG. 4. Another test image 30a may include 256 block images 31a (the gray-level status shown in FIG. 4 does not have any color difference), and the test image 30a simultaneously displays 0 to 255 gray-level values for green with the block images 31a. Therefore, the test image 30a only needs to be generated once to display all gray-level diagrams for green.

### Step 202:

A light sensor 71 is utilized to capture the test image 30 to generate captured image information 40 and sends the captured image information 40 to the color analyzer 72. The light sensor 71 may be a CCD or CMOS light sensing device, and the captured image information 40 may be digital image information.

### Step 203:

The color analyzer 72 analyzes the captured image information 40. The color analyzer 72 is a device which is known as a prior art. The color analyzer 72 analyzes the color information obtained from the color display 90 (such as the color temperature of each gray-level, as well as brightness and chromaticity) and sends the information to the computer 73.

The color analyzer 72 is used for analyzing the corresponding brightness values of different gray-level values in the block images 31. For example, the test image 30 may include 32 green block images 31, and so there may be analyzed to 32 corresponding brightness values.

### Step 204:

The computer 73 records the plurality of brightness values. The computer 73 may be a typical personal computer. A memory 732 within the computer 73 stores computer software and the plurality of brightness values. A processor 731 executes the computer software and processes data.

Taking the test image 30, including 32 green block images 31, as an example, from the description in step 201, the test image 30 should be generated 8 times to display all 0 to 255 of the gray-level diagrams for green. Therefore, step 201 to step 204 may be repeated 8 times, and then step 205 may be performed.

However, considering the test image 30a shown in FIG. 4, the test image 30a includes 256 gray-level diagrams for greenwith the block images 31a, and so steps 201 to 204 only need to be performed once, whereupon step 205 may be performed.

Alternatively, test images for white, red, green and blue may all be processed by the above-mentioned steps before step 205 is performed.

### Step 205:

The computer 73 generates a gray-level versus brightness curve 60 according to the plurality of brightness values and their corresponding plurality of gray-level values, as shown in FIG. 5.

In the above-mentioned embodiments, the test images 30, 30a respectively have 32 block images 31 and 256 block images 31a; however, various numbers of block images are possible. If n is the number of block images, then in various embodiments 2≦n≦m, wherein m is the maximum number of gray-level values that can be displayed on the color display 90 (the typical color display can generally display 256 shades, and so m=256; however, a high definition TV can display 4096 shades, and so in this case m=4096). When n is smaller, more time is needed to generate the gray-level versus brightness curve 60; conversely, when n is larger, less time is needed to generate the gray-level versus brightness curve 60. For example, in a typical TV with 256 shades up to the maximum gray-level value, if the test image 30 includes 32 green block (n=32) images 31, as described in step 201, then the test image 30 should be generated 8 times to display all 0 to 255 gray-level diagrams for green (by repeating steps 201 to 204 8 times). However, the test image 30a has 256 green gray-level diagrams of block images 31a, and steps 201 to 204 only need to be performed once. But when n is smaller, the accuracy of the gray-level versus brightness curve 60 is higher, as each block included in the same sized test image is larger; therefore, and the difference for the light sensor 71 to capture each different gray-level block is smaller. On the other hand, when n is larger, each block included in the same sized test image is smaller, and the difference for the light sensor 71 to capture each different gray-level block is higher.

It is not necessary to have 256 block images to obtain the gray-level versus brightness curve for 0 to 255 gray-level values; for example, the test image may include 64 block images, in which the gray-level value input into the nth block image is the 4×(n−1)th gray-level. Hence, the gray-level value input into the 1st block image is the 0th gray-level; the gray-level value input into the 2nd block image is the 4th gray-level; the gray-level value input into the 3rd block image is the 8th gray-level, and the gray-level value input into the 64th block image is the 252nd gray-level, etc. A gray-level versus brightness curve 60 with a somewhat lower accuracy may thus be generated. Alternatively, the gray-level value input into the nth block image may be the (4×n−2)th gray-level; the gray-level value input into the 1st block image is the 2nd gray-level; the gray-level value input into the 2nd block image is the 6th gray-level; the gray-level value input into the 3rd block image is the 10th gray-level, and the gray-level value input into the 64th block image is the 254th gray-level, etc. A gray-level versus brightness curve 60 with a slightly lower accuracy may thus be generated. Of course, the gray-level values separated out into the above-mentioned 64 block images are not exactly the same with each other; however, a few sections may be identical, which may cause the later gray-level versus brightness curve 60 to have a reduced accuracy. In addition to the above-mentioned two regular gray-level value distribution methods, an irregular gray-level value distribution method may also be utilized in the present invention. For example, the gray-level value input into the 1st block image may be the 0th gray-level; the gray-level value input into the 2nd block image may be the 1st gray-level; the gray-level value input into the 3^{rd} block image may be the 6th gray-level; the gray-level value input into the 4th block image may be the 11th gray-level; the gray-level value input into the 5th block image may be the 19th gray-level and so on up to the gray-level value input into the 64th block image, which may be the 255th gray-level, etc. A gray-level versus brightness curve 60 with a relatively lower accuracy may thus be generated.

Although the present invention has been explained in relation to its preferred embodiment, it is to be understood that many other possible modifications and variations can be made without departing from the spirit and scope of the invention as hereinafter claimed. For example, “the test image includes n block images, and each block image has a corresponding different gray-level value” does not necessarily mean that all block images of the test image have to have different gray-level values. For example, if the test image includes 64 block images, in which the gray-level values of 10 block images are identical to the gray-level value of another block so that only 54 block images all have different gray-level values, this still satisfies “the test image includes n (n=54) block images, and each block image has a corresponding different gray-level value.”

What is claimed is:

1. A method of rapidly generating a gray-level versus brightness curve for a display, the method comprising:
step A: providing an image signal to a color display to display a test image, wherein the test image includes n block images, each block image having a different gray-level value, and the color display can display a maximum of m different gray-level values, wherein 2≦n≦m;
step B: capturing the test image to generate captured image information; and
step C: analyzing the captured image information to obtain n brightness values.

2. The method of rapidly generating a gray-level versus brightness curve for a display as claimed in claim 1, wherein in step A, a signal generator is utilized to generate the image signal.

3. The method of rapidly generating a gray-level versus brightness curve for a display as claimed in claim 2, wherein in step B, a light sensor is utilized to capture the test image.

4. The method of rapidly generating a gray-level versus brightness curve for a display as claimed in claim 3, wherein in step C, a color analyzer is utilized for analyzing the captured image information.

5. The method of rapidly generating a gray-level versus brightness curve for a display as claimed in claim 1 further comprising step D: recording the n brightness values.

6. The method of rapidly generating a gray-level versus brightness curve for a display as claimed in claim 5, wherein in step D, a computer is utilized for recording the n brightness values.

7. The method of rapidly generating a gray-level versus brightness curve for a display as claimed in claim 5 further comprising step E: generating a gray-level versus brightness curve according to the n brightness values and their corresponding n gray-level values.

8. The method of rapidly generating a gray-level versus brightness curve for a display as claimed in claim 1, wherein in step C, a color analyzer is utilized for analyzing the captured image information.

9. The method of rapidly generating a gray-level versus brightness curve for a display as claimed in claim 8, wherein the test image is a pure color, and the pure color is at least one of the following colors: white, red, green and blue.

10. The method of rapidly generating a gray-level versus brightness curve for a display as claimed in claim 9, further comprising step D: recording the n brightness values.

11. The method of rapidly generating a gray-level versus brightness curve for a display as claimed in claim 10, wherein in step D, a computer is utilized for recording the n brightness values.

12. The method of rapidly generating a gray-level versus brightness curve for a display as claimed in claim 1, further comprising step E: generating a gray-level versus brightness curve according to the n brightness values and their corresponding n gray-level values.

13. A device for rapidly obtaining a gray-level versus brightness curve for a color display, wherein the color display is capable of displaying a maximum of m different gray-level values; the device comprising:
a signal generator for generating an image signal to the color display so the color display displays a test image; wherein the test image includes a plurality of block images, each block image having a different gray-level value, wherein 2≦n≦m;
a light sensor for capturing the test image to generate captured image information; and
a color analyzer electrically connected to the light sensor for analyzing the captured image information to obtain n brightness values.

14. The device as claimed in claim 13 further comprising a computer electrically connected to the color analyzer for recording the n brightness values.

15. The device as claimed in claim 14, wherein the test image is a pure color, and the pure color is at least one of the following colors: white, red, green and blue.

16. The device as claimed in claim 14, wherein the computer generates a gray-level versus brightness curve according to the n brightness values and their corresponding n gray-level values.

17. The device as claimed in claim 13, wherein the test image test image is a pure color, and the pure color is at least one of the following colors: white, red, green and blue.
